(19) United States
(12) Patent Application Publication
(10) Pub. No.: US 2010/0002142 A1
(43) Pub. Date: Jan. 7, 2010

(54) SYSTEM AND METHOD FOR VIDEO-PROCESSING ALGORITHM IMPROVEMENT

(76) Inventors: Alan Matthew Finn, Hebron, CT (US); Pei-Yuan Peng, Ellington, CT (US); Steven Barnett Rakoff, Toronto (CA); Pengju Kang, Yorktown Heights, NY (US); Ziyou Xiong, Wethersfield, CT (US); Lin Lin, Manchester, CT (US); Christian M. Netter, West Hartford, CT (US); James C. Moran, Oakville (CA); Ankit Tiwari, West Hartford, CT (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/449,476

(22) PCT Filed: Feb. 8, 2007
(86) PCT No.: PCT/US2007/003355

§ 371 Date: Aug. 10, 2009

(51) Int. Cl. H04N 5/262

(52) U.S. Cl. 348/571; 348/E05.051

(57) ABSTRACT

A method for improving a video-processing algorithm (36) identifies Video data (48) that may have been misinterpreted by the video-processing algorithm (36). The identified video data (48) is provided to a monitoring center (38) that uses the identified video data (48) to modify and improve upon the video-processing algorithm (36). An improved video-processing algorithm (49) is able to correctly analyze the identified video data (48).

### BACKGROUND OF THE INVENTION

The present invention relates generally to video-processing algorithms, and in particular to improvement of video-processing algorithms.

The term “video-processing algorithm” is used broadly to describe any computer algorithm that may be applied to interpret or analyze video data. For example, video content analysis (VCA) is a type of video-processing algorithm that is applied to video data in order to perform functions such as detecting, tracking, and classifying objects within the video data. Based on the results of the video content analysis, decisions can be made regarding whether the video data indicates events such as security breaches, intruder detection, fire detection, and objects left behind or removed. Another type of video-processing algorithm is known as a video quality diagnostic (VQD) algorithm, which is used to detect and quantify deficiencies in the quality of the video signal. In this way, video processing algorithms provide the benefit of automatically detecting events and situations that would otherwise require constant monitoring by a human operator.

Video-processing algorithms such as VCA and VQD are comprised of a number of mathematical functions designed to interpret video data. These functions include background or foreground subtractions, filtering, tracking, classifications, and others. Design of video-processing algorithms requires adjusting the numerous mathematical functions and associated parameters making up the video-processing algorithm such that the video-processing algorithm is capable of correctly analyzing video data to identify and detect real world events.

In general, design of the video-processing algorithms is done by analyzing a number of saved video clips using the video-processing algorithm. The video-processing algorithm is altered (by adjusting the parameters associated with the numerous mathematical functions) until the video-processing algorithm is able to correctly analyze situations presented in the saved video clips. For example, a video-processing algorithm designed to detect intruders in an outdoor setting must be capable of differentiating between a shadow created by a passing cloud and an intruder. Based on saved video clips illustrating shadows created by a passing cloud, parameters of a background subtraction function are altered and tuned until the video-processing algorithm is able to correctly identify video clips illustrating shadows created by passing clouds and video clips of an intruder.

However, because the video-processing algorithms are designed prior to installation in the field, it is possible for scenarios to arise in the field that were not anticipated at the design stage. In other words, because the collection of video clips used to design and test the video-processing algorithm is limited in size, not every situation can be accounted for in the design stage, and it is possible for situations to arise in the field that will be misinterpreted by the video-processing algorithm. For instance, in the above example in which the video-processing algorithm is programmed to differentiate between a shadow created by a passing cloud and an intruder moving through a secured region, the video-processing algorithm may in principle mistake a burglar dressed all in black and moving slowly as a shadow created by a passing cloud. In this (simplified) example, the video-processing algorithm fails to correctly identify the real-world event.

Therefore, it would be beneficial to provide a method of improving video-processing algorithms.

### BRIEF SUMMARY OF THE INVENTION

A method for improving video-processing algorithms includes acquiring video data and analyzing the acquired video data using a first video-processing algorithm. Video data that is improperly analyzed by the first video-processing algorithm is identified and provided to a monitoring center. Based on the identified video data provided to the monitoring center, the first video-processing algorithm is modified such that the identified video data would be correctly analyzed by the improved video-processing algorithm. The first video-processing algorithm, or part thereof (such as a parameter value), is then replaced with the improved video-processing algorithm, or part thereof.

In another aspect, a system for improving video-processing algorithms based on video feedback is provided. The system for improving video-processing algorithms includes means for acquiring video data, means for analyzing the acquired video data using a video-processing algorithm, and means for identifying video data improperly analyzed by the video-processing algorithm. Identified video data is communicated to a monitoring center that uses the identified video data to improve the video-processing algorithm. The video-processing algorithm, or part thereof, is then replaced with the improved video-processing algorithm, or part thereof.

### BRIEF DESCRIPTION OF THE DRAWINGS

FIGS. 1A and 1B are a functional block diagram and flowchart that illustrate the design of video-processing algorithms to be deployed to a fielded system as known in the prior art.

FIG. 2 is a functional block diagram of video-processing algorithm improvement system that provides video data feedback for video-processing algorithm improvement.

FIG. 3 is a flowchart of a method for video-processing algorithm improvement based on video data feedback.

### DETAILED DESCRIPTION

The present disclosure describes a system and method for improving video-processing algorithms based on video data feedback produced by a fielded system. The fielded system captures video data from a number of video devices, and analyzes the video data captured in a real-world setting using a first video-processing algorithm. If the first video-processing algorithm incorrectly interprets the video data, then the video data that was incorrectly interpreted by the video-processing algorithm is stored and communicated to a monitoring center. Based on the video data provided, modifications are made to the video-processing algorithm such that the improved video-processing algorithm is able to correctly identify the missed event. The improved video-processing algorithm is then uploaded, or communicated to the fielded system, replacing all or part of the original video-processing algorithm. In this way, feedback provided by the fielded system is used to improve the video-processing algorithm of the fielded system.

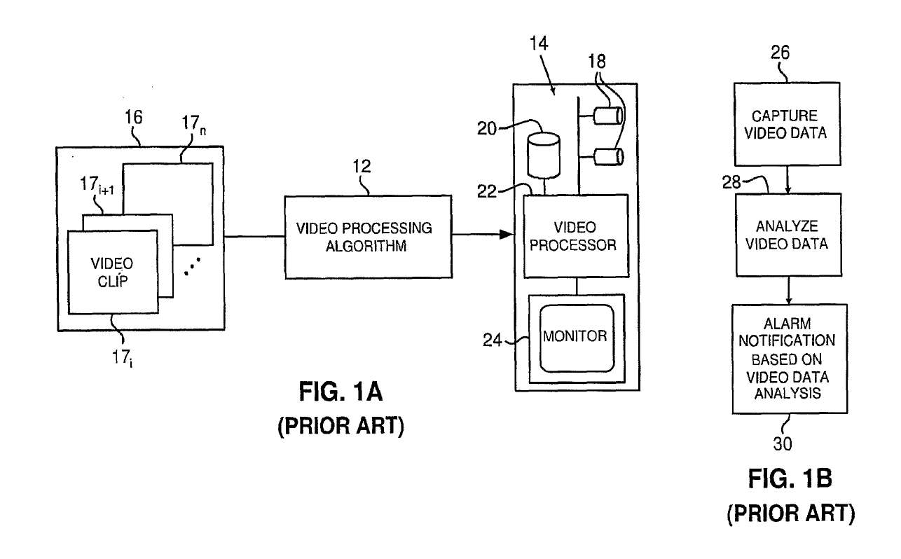

FIG. 1A illustrates one prior art method of designing and testing a video-processing algorithm 12 to be deployed to a fielded system 14. Design and testing of video-processing algorithm 12 is based on video clip collection 16, which includes a plurality of individual video clips 17ᵢ, 17ᵢ₊₁ . . . 17ₙ.

Following design and testing of video-processing algorithm 12, the algorithm is installed on fielded system 14, which includes camera 18, storage device 20, processor 22, and monitor 24.

Fielded system 14 performs the functions shown in the flow chart shown in FIG. 1B. These functions include the capture of video data within the field of view of camera 18 (step 26), video processing of the captured video data based on the video-processing algorithm provided (step 28), and alarm notification based on the results of the video-processing algorithm (step 30).

As shown in FIG. 1A, video-processing algorithm 12 is designed and tested based on video clip collection 16. Each of the video clips 17ᵢ-17ₙ included in video clip collection 16 represents a real world event or situation. Testing and tuning of video-processing algorithm 12 ensures correct identification of events depicted in video clip collection 16. The design of video-processing algorithm 12 includes setting a number of parameters that determine how video-processing system (specifically, the mathematical functions making up video-processing system) interprets video data. Proper initialization of these parameters results in video-processing algorithm 12 being capable of correctly identifying events in each video clip 17ᵢ-17ₙ making up video clip collection 16.

Once deployed, fielded system 14 uses video-processing algorithm 12 to monitor and detect events based on video data provided by cameras 18. At step 26 (as shown in FIG. 1B), camera 18 captures video data within the camera's field of view. At step 28, the captured video data is provided to video processor 22, which uses video-processing algorithm 12 to analyze the captured video data. At step 30, alarm notification or other action is taken based on the results of the video-processing analysis of the captured video data.

Therefore, in the prior art system described with respect to FIG. 1A, once video-processing algorithm 12 is installed on fielded system 14 there is no way to update or improve video-processing algorithm 12. In particular, if fielded system 14 fails to detect an event (“missed detection”) or falsely sounds an alarm (“false alarm”), there is no way to customize video-processing algorithm 12 to improve the performance of fielded system 14.

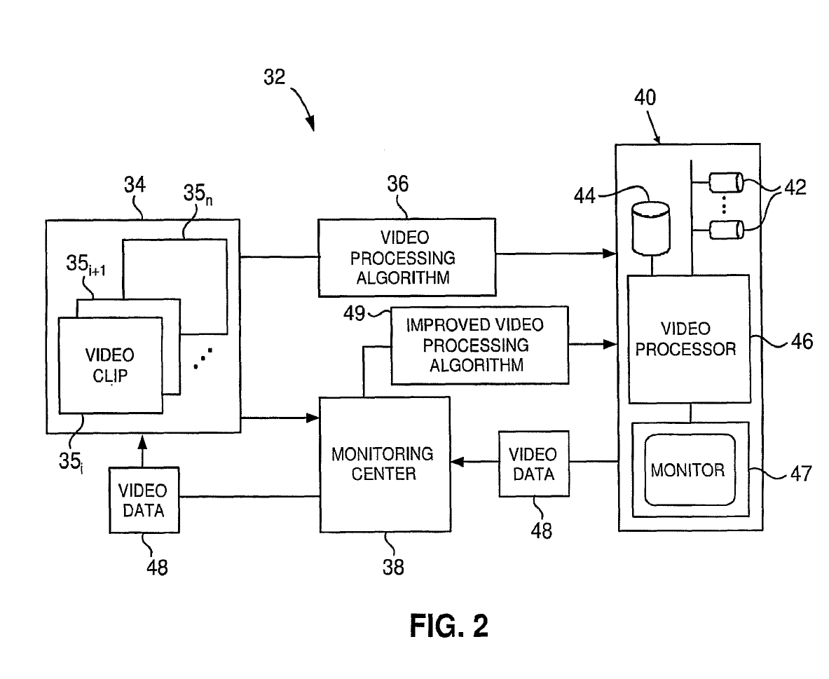

FIG. 2 illustrates an exemplary embodiment of a video algorithm improvement system that provides for the continued refinement and improvement of a video-processing algorithm installed in a fielded system based on video feedback provided by the fielded system.

In this embodiment, video algorithm improvement system 32 includes video clip collection 34, which includes individual video clips 35ᵢ, 35ᵢ₊₁ . . . 35ₙ, video-processing algorithm 36, monitoring center 38, and fielded system 40, which includes but is not limited to the following: at least one video device 42, local storage device 44, video processor 46, and monitor 47. In one embodiment, fielded system 40 (except for video devices 42) is implemented with a digital video recorder (DVR) device capable of providing video analysis. Any number of devices capable of capturing or receiving video data and processing video data may be used.

Video algorithm improvement system 32 is initialized in much the same way as the prior art system shown in FIG. 1A. Video-processing algorithm 36 is initially designed and tested based on video clip collection 34. That is, parameters defining the response of video-processing algorithm 36 are adjusted such that video-processing algorithm 36 is able to correctly identify situations presented by video clip collection 34. In this way, video-processing algorithm 36 is able to correctly identify events in each of the video clips 35ᵢ, 35ᵢ₊₁ . . . 35ₙ making up video clip collection 34. Video-processing algorithm 36 is then loaded or communicated to fielded system 40.

Communication of video-processing algorithm 36 to video content analysis system 40 may be done via any number of manufacturing or communication methods, including but not limited to plain old telephone service (POTS) connection with modem or local area network (LAN) connections. Video-processing algorithm may also be saved to a portable medium such as compact disc (CD) or a flash digital storage drive, and physically installed on fielded system 40. Video processing algorithm may be saved to local storage device 44 or within memory local to video processor 46.

Once fielded system 40 is loaded with video-processing algorithm 36, video devices 42 begin capturing video data and providing the video data to video processor 46. The video data is analyzed by video processor 46 using video-processing algorithm 36. Analysis of video data includes, but is not limited to, video content analysis (VCA) (such as object detection and classification, intruder detection, and left bag detection, etc.) as well as video quality diagnostic (VQD) (such as field of view obscuration, blur, out-of-focus, etc.).

Based on the video-processing algorithm analysis of the video data, a couple of scenarios are of interest. In the case in which video processor 46 detects an event that requires sounding an alarm (such as detection of an intruder) then a security service is provided with alarm information as well as video data resulting in the alarm on monitor 48. A user or operator visually inspects the video data that resulted in the alarm and determines whether the alarm is accurate or not. If the alarm is accurate, then fielded system 40 (including video-processing algorithm 36) correctly analyzed the video data. If the alarm is not accurate (i.e., a false alarm), then video-processing algorithm 36 may have incorrectly interpreted the video data. In the latter scenario, the user or operator may designate the video data that led to the false alarm.

In another scenario, video-processing algorithm 36 fails to detect an event that should have resulted in an alarm or notification. This condition, although no less important, is sometimes more difficult to detect. Unlike false alarms that result in notification of a user, these events are not detected by video-processing algorithm 36, and therefore are not necessarily reviewed by a human operator. Oftentimes, missed detections are not identified until some time after the event occurs. For instance, missed intruder detection will typically go unnoticed until other evidence of the intruder, such as a report of stolen property, alerts security to the breach. Therefore, in order to identify video data that results in missed detections, it is often necessary to store the video data for some limited amount of time. In the case in which nothing unexpected happens, then the video data can be discarded. In the case in which a later event indicates a missed detection, then the stored video data can be searched until the video data that resulted in the missed detection is found. Not only is the video data useful for forensic purposes, but is also useful for adjusting parameters of video-processing algorithm 36 to ensure detection of future events.

Similarly, a security service may be notified (based on VQD analysis) of a quality issue associated with a video device. Once again, an operator at the security service visually inspects the video data resulting in the notification to determine whether the notification was proper. If the notification was not proper, then the security services identifies the video data as being improperly analyzed by the video-processing algorithm.

In one embodiment, monitor 47 includes an interface that allows the user to designate video data as having been incorrectly analyzed. In one embodiment, the interface may be a touch-screen display incorporated within monitor 47 that includes a button for designating video data as being incorrectly analyzed by video-processing algorithm 36. For example, if upon visual inspection of video data responsible for initiating the alarm the user or operator decides that fielded system 40 incorrectly initiated an alarm, then the user touches a false alarm button on the touch-screen display to designate the video data as a false alarm. A similar button may be displayed for each specific situation (such as missed detections) or a single button may simply designate without further distinction that the video data was incorrectly analyzed by video-processing algorithm 36. Alternatively, a simpler interface system consisting of a keyboard, mouse, or physical button (not shown) may be provided to allow a user to designate whether video data has been incorrectly analyzed.

Video data designated as incorrectly analyzed are saved in local storage device 44 prior to being communicated to monitoring center 38. In one embodiment, storage medium 44 is implemented as a rolling buffer that stores video data on a priority basis, with the least recent or lowest priority video data being overwritten by more recent or higher priority video data. For example, storage medium 44 may store all video data for a limited amount of time (which as described above is useful for identifying missed detections). The oldest saved video data (lowest priority) would be overwritten by the most recently recorded video data (higher priority). Video data designated by a user as indicating a false alarm or missed detection would be given higher priority status, and would not be overwritten until properly transmitted to monitoring center 38. Transmission of stored video data from local storage medium 44 to monitoring center 38 may be done either periodically or upon request.

Bi-directional communication between fielded system 40 and monitoring center 38 allows video data 48 identified by fielded system 40 as incorrectly analyzed by video-processing algorithm 36 to be communicated to monitoring center 38 for algorithm improvement, and also allows updated or improved video processing algorithms 49, or parts thereof, to be uploaded or provided to fielded system 40. The bi-directional communication between fielded system 40 and monitoring center 38 may be implemented via a standard plain old telephone service (POTS) line coupled with a modem or via a local area network (LAN) connection (as discussed above). Communication of incorrectly analyzed video data 48 from fielded system 40 to monitoring center 38 is done with the provision that the uploading may be interrupted at any time by a higher priority communication. Video data 48 uploaded to monitoring center 38 may also have a locally computed message authentication code (MAC) code for ease of determining successful transmission. This allows monitoring center 38 to acknowledge successful receipt of video data 48 before it is erased from local storage medium 44 in fielded system 40, subject to buffer size limits described above.

In one exemplary embodiment, monitoring center 38 is a remote site that is physically separated from fielded system 40. For example, video processing algorithm 36 may be deployed to a number of locations for use in surveillance or security applications. A remote site or monitoring center 38 is connected to receive video data feedback from any of the locations employing video processing algorithm 36. Based on received video data 48 indicating misinterpreted video data, monitoring center 38 is capable of making improvements to video processing algorithm 36.

At monitoring center 38, a programmer or automatic algorithm interpreter uses video data 48 to determine whether video-processing algorithm 36 may be adjusted or improved to prevent future false alarms. Improvement of video-processing algorithm 36 involves altering the mathematical functions and associated parameters that define video-processing algorithm 36. Ideally, adjustments made to video-processing algorithm 36 result in improved video-processing algorithm 49 correctly analyzing video data 48 provided by fielded system 40 without negatively affecting the ability of video-processing algorithm 49 to detect other situations. To this end, the programmer or automatic algorithm interpreter may conduct regression testing that includes testing improved video-processing algorithm 49 against video clips 35ᵢ, 35ᵢ₊₁ . . . 35ₙ stored in video clip collection 36. Regression testing ensures that improved video processing algorithm 49 does not incorrectly analyze video data that was correctly analyzed by video processing algorithm 36. Assuming the regression tests do not indicate a degradation or negative impact on performance of improved video-processing algorithm 49, then improved video-processing algorithm 49 is uploaded or communicated to fielded system 40, replacing entirely or in part original video-processing algorithm 36.

To improve future design and testing of video processing algorithms, video data 48, which represents a real world condition misinterpreted by original video-processing algorithm 36, is added to video clip collection 34. By expanding video clip collection 34 with additional clips of video data (such as video data 48), future versions or designs of video-processing algorithms will incorporate the adjustments required to accurately interpret each of the situations presented in video clip collection 34.

In the previous examples that describe scenarios related to missed detections and false alarms, a user such as a security guard manually inspected video data to determine whether the video data was incorrectly analyzed by video processing algorithm 36. In another embodiment, no input is required from a user to identify incorrectly analyzed video data. Instead, as video-processing algorithm 36 processes video data, the video-processing algorithm itself identifies video data that may have been improperly analyzed based on the results of the analysis. In one embodiment, video-processing algorithm 36 generates an uncertainty value associated with the video processing analysis. A high uncertainty value indicates a lack of certainty with regard to the outcome of the video processing analysis. For example, the result of analysis performed by video-processing algorithm 36 may indicate the presence of a shadow created by a cloud, but the analysis may indicate a degree of uncertainty regarding the classification of the object as a shadow created by a cloud. The uncertainty may be due to the unusual movement of the shadow, or color of the shadow that results in uncertainty regarding the analysis of video processing algorithm 36. In this instance, the video data may be automatically identified as potentially containing video data that was misinterpreted by video processing algorithm 36. The identified video data (shown by video data 48 in FIG. 2) would be communicated to monitoring center 38 for further analysis and algorithm improvement if necessary. Thus, analysis of video data that results in a certain degree of uncertainty may be automatically reviewed for algorithm improvement without requiring a manual review by a human user.

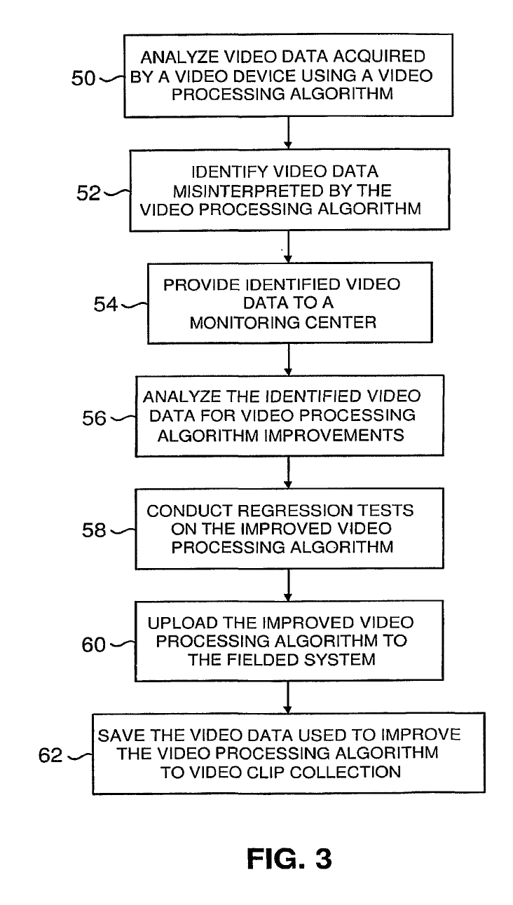

FIG. 3 is a flowchart illustrating steps in one embodiment of the present invention. Steps are discussed with respect to video algorithm improvement system 32 described with respect to FIG. 2. Although the steps are numbered sequentially, the step numbers do not imply an order in which the steps must be performed.

At step 50, fielded system 40 analyzes video data provided by at least one video device 42 using a first video-processing algorithm (i.e., video-processing algorithm 36 initially loaded onto fielded system 40). The first video-processing algorithm is designed and tested based on video clip collection 34.

At step 52, failure to recognize or correctly analyze video data (such as missed detections or false alarms) is detected. As discussed above, identification of video data containing missed detections or false alarms may be manual or automatic. For manual detection a security guard or other personnel visually inspects video data to determine if video-processing algorithm 36 correctly interpreted video data. In automatic detection, video processor 46 automatically identifies video data potentially resulting in missed detections or false alarms.

At step 54, video data 48 identified as potentially or actually incorrectly analyzed in FIG. 2 is provided to monitoring center 38. In one embodiment, identified video data 48 is stored to local memory storage 44 prior to communication to monitoring center 38. Once stored, video data 48 can be communicated to monitoring center 38 at a convenient time for further analysis. For example, stored video data 48 may be periodically transferred on a calendar basis from the local memory storage 44 to monitoring center 38. Video data 48 may also be transferred from local memory storage 44 to monitoring center 38 on an event-driven basis, such as upon request from monitoring center 38.

At step 56, video data 48 uploaded to monitoring center 38 is analyzed. Video data analysis may be performed by an automatic algorithm interpreter or by human interpreters for possible video content analysis (VCA) and video quality diagnostic (VQD) algorithm tuning improvements. Based on the analysis performed, parameters defining video-processing algorithm 36 (which is currently loaded in the video-processing system) are adjusted or fine-tuned in response to video data 48. The adjustments to all or part of video-processing algorithm 36 results in an improved video-processing algorithm (illustrated in FIG. 2 as improved video processing algorithm 49) that correctly interprets events in video data 48. Alternatively, entirely new algorithms may be developed to replace or augment the video-processing algorithm currently loaded in the video-processing system.

At step 58, improved video-processing algorithm 49 is optionally submitted for regression tests to ensure that changes made in the video-processing algorithm to identify the previously misinterpreted situation does not result in the misinterpretation of video clips 35ᵢ, 35ᵢ₊₁ . . . 35ₙ stored in video clip collection 34, which were analyzed correctly by video processing algorithm 36. Regression tests typically include analyzing video clips 35ᵢ, 35ᵢ₊₁ . . . 35ₙ stored in video clip collection 34 to ensure the overall performance of improved video-processing algorithm 49 is not compromised to correctly identify a single instance of incorrectly interpreted video data. At step 60, following satisfactory regression tests, improved video-processing algorithm 49 is uploaded to fielded system 40, replacing all, or some part thereof, of video-processing algorithm 36. In one embodiment, improved video-processing algorithm 49 is only uploaded to fielded system 40 pending the approval of the customer employing the video content analysis system. In another embodiment, the uploading of improved video-processing algorithm 49 is accompanied by an ability to roll-back the installation of improved video-processing algorithm 49 to a previous version (e.g., video processing algorithm 36). In this way, if the performance of improved video-processing algorithm 49 is unsatisfactory to a customer (e.g., improved video-processing algorithm 49 fails to perform as well as video-processing algorithm 36), then the customer may replace improved video-processing algorithm 49 with the previous version.

At step 62, video data 48 used to improve video-processing algorithm 36 is saved as a video clip to video clip collection 34. The addition of video data 48 used to generate video processing algorithm 49 may be used to program and test future video-processing algorithms, ensuring that each future video-processing algorithm can accurately interpret the situation presented in video data 48.

Step 50 is then repeated, with improved video-processing algorithm 49 being used to analyze video data. Further improvements may be made to the improved video-processing algorithm 49 as additional video data representing false alarms and missed detections are provided to monitoring station 38 for analysis.

Although the present invention has been described with reference to preferred embodiments, workers skilled in the art will recognize that changes may be made in form and detail without departing from the spirit and scope of the invention. For example, although the present invention has been taught using a single DVR in the fielded system, the present invention is applicable to any digital video system. Similarly, although video content analysis and video quality diagnostic was specifically discussed, the present invention may be extended to monitoring and improvements of other types of algorithm performance.

In addition, a number of embodiments and examples relating to the use of video algorithm improvement system in a security environment have been described, although the system is applicable to any number of fields or applications that employ video data analysis.

Furthermore, throughout the specification and claims, the use of the term “a” should not be interpreted to mean “only one”, but rather should be interpreted broadly as meaning “one or more.” The use of sequentially numbered steps used throughout the disclosure does not imply an order in which the steps must be performed. In addition, the use of the term “first” or “second” does not necessarily imply order.

The use of the term “or” should be interpreted as being inclusive unless otherwise stated. For instance, the statement that video data may be designated as improperly analyzed automatically by video processor 45 or manually by a human operator should be interpreted broadly to include the situation in which both automatic and manual detection of incorrectly analyzed video is employed.

1. A method of improving video-processing algorithms, the method comprising:
acquiring video data;
analyzing the acquired video data using a first video-processing algorithm (50);
identifying video data incorrectly analyzed by the first video-processing algorithm (52);
communicating the identified video data to a remote site (54);
creating a second video-processing algorithm based on the video data identified as incorrectly analyzed by the first video-processing algorithm (56); and
replacing the first video-processing algorithm with the second video-processing algorithm (60).

2. The method of claim 1, wherein creating the second video-processing algorithm includes:
modifying the first video-processing algorithm to correctly analyze the video data identified as incorrectly analyzed by the first video-processing algorithm.

3. The method of claim 2, wherein modifying the first video-processing algorithm further includes:
modifying mathematical functions or parameters associated with the first video-processing algorithm.

4. The method of claim 1, further including:
performing a regression test on the second video-processing algorithm to determine whether the second video-processing algorithm performs as well as the first video-processing algorithm (58).

5. The method of claim 1, further including:
adding the video data identified as incorrectly analyzed by the first video-processing algorithm to a video clip collection used to design and test performance of video-processing algorithms (60).

6. The method of claim 1, wherein identifying video data incorrectly analyzed by the first video-processing algorithm includes:
manually inspecting the video data to determine whether the video data has been incorrectly analyzed by the first video-processing algorithm.

7. The method of claim 1, wherein identifying video data incorrectly analyzed by the first video-processing algorithm includes:
automatically identifying video data as incorrectly analyzed based on video-processing analysis performed by the first video processing algorithm.

8. The method of claim 7, wherein automatically identifying video data as incorrectly analyzed includes:
determining whether the video data has been incorrectly analyzed based on uncertainty values calculated by the first video-processing algorithm with respect to the video data.

9. A system for improving video-processing algorithms, the system comprising:
a fielded system (40) comprising:
means for acquiring video data (42);
means for analyzing the acquired video data (46) using a video-processing algorithm (36); and
means for identifying video data incorrectly analyzed by the video-processing algorithm;
a remote site (38) connected to receive from the fielded system (40) video data (48) identified as incorrectly analyzed by the video-processing algorithm (36), wherein the remote site (38) includes means for improving the video-processing algorithm based on the received video data (48) and for updating the means for analyzing the acquired data (46) with the improved video-processing algorithm (49).

10. The system of claim 9, further including:
a collection of video clips (34), wherein each video clip (35ᵢ, 35ᵢ₊₁ . . . 35ₙ) included in the collection (34) illustrates a situation that should be correctly analyzed by the improved video-processing algorithm (49); and
wherein the remote site (38) performs regression testing on the improved video-processing algorithm (49) using the collection of video clips (34) to test overall performance of the improved video-processing algorithm (49).

11. The system of claim 10, wherein the remote site (38) stores the received video data (48) identified as incorrectly analyzed by the video-processing algorithm (36) to the collection of video clips (34).

12. The system of claim 9, wherein the remote site (38) includes:
an automatic algorithm interpreter that adjusts parameters associated with the video-processing algorithm (36) based on the video data (48) identified as incorrectly analyzed by the video-processing algorithm (36).

13. The system of claim 9, wherein the means for identifying video data improperly analyzed by the video-processing algorithm includes:
a monitor (47) that allows a human operator to manually inspect the analyzed video data to identify video data that was incorrectly analyzed by the video processing algorithm (36).

14. The system of claim 13, further including:
a user interface connected to allow the human operator to identify video data incorrectly analyzed by the video processing algorithm (36).

15. The system of claim 9, wherein the means for identifying video data incorrectly analyzed by the video-processing algorithm (36) includes:
means for automatically identifying video data that may have been incorrectly analyzed by the video-processing algorithm (36) based on analysis performed by the video processing algorithm (36).

16. The system of claim 15, wherein the means for automatically identifying video data that may have been incorrectly analyzed includes:
generating uncertainty values associated with the analyzed video data, wherein the generated uncertainty values are used to automatically identify video data (48) that may have been incorrectly analyzed by the video-processing algorithm (36).

17. A system for improving video-processing algorithms, the system comprising:
a video analysis system (40) comprising:
at least one video detector (42) for capturing video input;
a video processor (46) that uses a video-processing algorithm (36) to analyze the video input provided by the at least one video detector (42) and to provide output based on the analyzed video input;
a monitor (47) for reviewing analysis performed by the video processor (46) to ensure the video-processing algorithm (36) correctly interprets the provided video input, wherein video input improperly interpreted by the video-processing algorithm is identified;
a remote site (38) connected to receive video input (48) identified as improperly interpreted by the video-processing algorithm (36) from the video analysis system (40), wherein the remote site (38) improves the video-processing algorithm (36) based on the identified video input (48) provided by the video analysis system (40), and updates the video analysis system (40) with an improved video-processing algorithm (49).

18. The system of claim 16, wherein the video analysis system (40) includes:
a local storage medium (44) for storing video input identified as improperly interpreted by the video-processing algorithm (36).

19. The system of claim 17, further including:
means for communicating video input from the video analysis system (40) to the remote site (36).

20. The system of claim 16, further including:
a collection of video clips (34) accessible to the remote site (38), wherein the remote site (38) performs a regression test on the improved video-processing algorithm (49) using the collection of video clips (34).
